(19) United States
(12) Patent Application Publication
(10) Pub. No.: US 2015/0024897 A1
(43) Pub. Date: Jan. 22, 2015

(54) TORQUE TRANSMITTING ASSEMBLY

(71) Applicants: Szuba Consulting, Inc., Dearborn, MI (US); Value Extraction LLC, Dearborn, MI (US)

(72) Inventor: Joseph Szuba, Dearborn, MI (US)

(73) Assignees: SUBA CONULTING, iNC., Dearborn (US); Value Extraction LLC, Dearborn, MI (US)

(21) Appl. No.: 14/380,411

(22) PCT Filed: Feb. 22, 2013
(86) PCT No.: PCT/US2013/027313

§ 371 Date: Aug. 22, 2014

Related U.S. Application Data
(60) Provisional application No. 61/612,732, filed on Mar. 19, 2012.

(30) Foreign Application Priority Data
Feb. 24, 2012 (US) 13404076

(51) Int. Cl. F16H 48/08; F16H 57/02; F16H 48/06

(52) U.S. Cl. CPC F16H 48/08; F16H 48/06; F16H 57/02
USPC 475/230; 74/606 R

(57) ABSTRACT

A torque transmitting assembly, such as a differential, including a tubular housing having a polygonal cross-section including a plurality of angularly related surfaces and a torque transmitting member within the housing having flat surfaces engaging the flat surfaces of the housing, such that torque is transmitted through the housing. In a differential, the torque transmitting member includes annular side gears having a plurality of annular teeth and annular pinion gears including gear teeth meshing with the gear teeth of the side gears.

### RELATED APPLICATIONS

This patent application claims priority to U.S. Provisional Application Ser. No. 61/612,732 filed on Mar. 19, 2012 and to Nonprovisional Application Ser. No. 13/404,076, filed Feb. 24, 2012, now U.S. Pat. No. 8,356,506 issued on Jan. 22, 2013.

### FIELD OF THE INVENTION

This invention relates to torque transmitting assemblies including a tubular steel housing having a polygonal cross-section, such as automotive differentials, drive bearings, transmission ring gears, etc.

### BACKGROUND OF THE INVENTION

Torque transmitting assemblies, such as an automotive differential, must be rugged and able to transmit torque from the driveshaft to the wheels. Thus, an automotive differential typically includes a cast or die formed metal housing which receives the pinion gears and side gears and the housing is bolded to the ring gear by twelve or more screws to withstand the torque from the driveshaft. As will be understood by those skilled in this art, the ring gear drives axel shafts which are connected to the brake assemblies and the vehicle wheels. An automotive differential is expensive, labor intensive and adds considerable weight to the vehicle. Nevertheless, automotive differentials have been made the same way for many decades. However, the automotive differential, particularly in heavy duty trucks, is still subject to failure for several reasons, including the torque applied to each of these screws which retain the ring gear on the housing.

There has, therefore, been a long felt need for an improved torque transmitting assembly which is stronger, weighs less and is less expensive to manufacture than conventional torque transmitting assemblies, including but not limited to an improved automotive differential. The improved torque transmitting assembly and differential of this invention solves the problems associated with the prior art as described more fully herein below.

### SUMMARY OF THE INVENTION

As set forth above, this invention relates to an improved torque transmitting assembly, including, but not limited to an improved automotive differential. The torque transmitting assembly of this invention has a tubular steel housing including a polygonal cross-section having a plurality of angularly related flat surfaces. As set forth herein, the housing may include a regular polygonal cross-section, such as an octagon, hexagon or square, or an irregular polygon wherein one or more sides are longer than the others, depending upon the application. The tubular housing may be formed from a welded seam tube or an un-seamed tube which is formed into the desired polygonal shape. In one preferred embodiment, the torque transmitting assembly further includes a ring gear including a central polygonal opening received on the polygonal cross-section of the housing and a plurality of external radial teeth, such that rotation of the ring gear also rotates the housing.

The torque transmitting assembly of this invention further includes a torque transmitting member located within the housing having flat surfaces engaging the angularly related internal flat surfaces of the housing, wherein the torque transmitting member transmits torsional force or torque through the steel housing member upon application of torque to the torque transmitting member. In some applications, such as an automotive differential, the torque transmitting member may comprise two gears, including a first gear member having a plurality of gear teeth and a second gear member having a plurality of gear teeth which mesh with the gear teeth of the first gear member, wherein the second gear member transmits torque to the tubular housing through the first gear member. The steel tube may then be rolled to form a smaller circular cross-section retaining the components in the tubular housing as described in this application.

The automotive differential or differential joint of this invention includes a tubular steel housing as described above including a polygonal cross-section having a plurality of angularly related flat surfaces, and an annular pinion gear or gears located within the housing including a flat exterior surface engaging the angularly related flat internal surfaces of the tubular housing and further including a plurality of inner annular gear teeth, and an annular side gear or gears including outer gear teeth meshing with the inner gear teeth of the pinion gear, wherein the annular side gear further includes an axial bore having a plurality of internal angularly related flat surfaces, such as a cylindrical splined surface. The automotive differential joint further includes a driveshaft having a plurality of external angularly related flat or splined surfaces meshing with the internal angularly related flat surfaces of the annular side gear, wherein the shaft transmits torque from the housing through the annular side gear and the annular pinion gear.

In one preferred embodiment of the automotive differential of this invention, the differential further includes an annular ring gear having an axial polygonal bore closely received around the polygonal cross-section of the housing including a plurality of angularly related internal flat surfaces engaging the external flat surfaces of the housing and including the plurality of external annular gear teeth. An automotive differential further includes a driveshaft including a pinion gear having a frustoconical end portion including gear teeth meshing with the gear teeth of the ring gear. Thus, rotation of the driveshaft rotates the ring gear and the housing and rotation of the housing rotates pinion gears and the side gears which rotated the axel shafts.

A tubular steel housing including a polygonal cross-section eliminates the requirement for bolts or screws interconnecting the components of the torque transmitting assembly, such as the housing and ring gear, thereby simplifying and strengthening the assembly and reducing labor costs.

The torque transmitting assembly, particularly including the automotive differential of this invention has several major advantages over the prior art. First, the invention results in major cost and weight savings, which is particularly important in automotive and aircraft applications. The assembly eliminates flange rings and mounting bolts for inter-connecting a ring gear to the housing. The assembly also has better balance through consistent wall material thickness versus irregular cast iron housing thicknesses and is capable of transmitting more torque, up to 70% more. The differential also results in a minimization of ring gear deflection or waffling and improved or reduced back lash of internal side gears to pinion gears. The assembly and differential of this invention also results in manufacturing savings, including the elimination of expensive equipment, including multiple transferred dies, high tonnage presses, coil handling equipment, press automation and part transfer equipment and scrap handlers. In fact, the differential of this invention results in scrap savings by an estimated 38% and 90% less machining chips and permits automatic assembly.

### BRIEF DESCRIPTION OF THE DRAWINGS

FIG. 1 is an end view of a housing member or preform for a torque transmitting assembly of this invention during processing;

FIG. 2 is a side partially cross-sectioned view of the perform housing member shown in FIG. 1;

FIG. 3 is an end view of the housing member shown in FIGS. 1 and 2;

FIG. 4 is a side cross-sectional view of the housing member shown in FIGS. 1 to 3 after further processing;

FIG. 5 is a side cross-sectional view of the housing member shown in FIGS. 1 to 4 following processing;

FIG. 6 is a side cross-sectional view of an automotive differential including the housing member shown in FIG. 5; and

FIG. 7 is a top partially cross-sectioned view of the differential shown in FIG. 6.

### DESCRIPTION OF THE PREFERRED EMBODIMENTS

As will be understood by those skilled in this art, various modifications may be made to the torque transmitting assembly and the automotive differential disclosed herein within the purview of the appended claims. In a preferred embodiment, the housing includes a polygonal cross-section and is formed of steel. The preferred steel will depend upon the application; however, in heavy duty applications, such as an automotive truck differential, the housing is preferably formed from a high strength low alloy (HSLA) steel. The preferred polygonal shape is also dependent upon the application. The housing may include a regular polygonal cross-section, such as an octagon, pentagon or even a square. Irregular polygonal shapes may also be preferred in certain applications. The torque transmitting assembly of this invention will now be described with regard to an automotive differential as exemplary only.

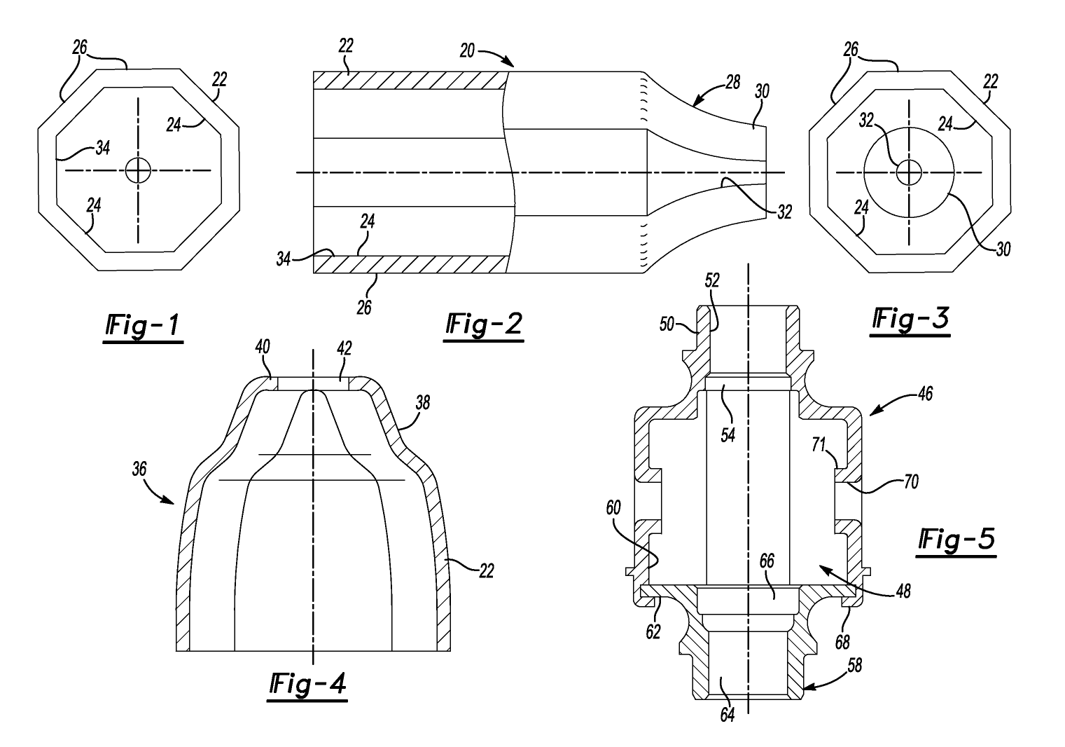

FIGS. 1 to 3 illustrate a tubular housing preform 20 including a polygonal cross-section 22 which, in the disclosed embodiment, is octagonal, including eight flat internal surfaces 24 and eight flat external surfaces 26, respectively. This embodiment of the tubular housing preform further includes a reduced diameter portion 28 which, in the disclosed embodiment, has a circular cross-section 30. As described in my co-pending patent application, the reduced diameter portion may be formed by rollers having a rolling axis parallel to the axis of the tube extending perpendicular to the tube. The tubular housing preform thus has a reduced diameter opening 32 which may be utilized to retain the components in the housing as described herein and an enlarged diameter opening 34 which may be used to receive the components or assembly in the housing.

The housing preform member is then cold worked, such as by rolling or spinning the housing preform on a mandrel as disclosed in my parent application, forming a flared portion 38 and an inwardly deformed lip 40 surrounding the reduced diameter opening 42 as shown in FIG. 4. As described, cold working materially strengthens the steel and the resultant housing. The cold worked partially formed housing may then be formed into the desired shape of the housing, such as the housing member 46 shown in FIG. 5. The housing member 46 includes a polygonal cross-section having an internal housing chamber 48 and an integral neck portion 50. The housing member includes an axial bore 52 which extends into the neck portion 50 and a counter bore 54.

The housing assembly in this embodiment further includes a cap or cover 58 shown in FIG. 6 which has an octagonal flange portion 62 received in the octagonal enlarged opening 60. The cap further includes an axial bore 64 coaxially aligned with the axial bore 52 of the housing and a counter bore 66. In this embodiment, the free end of the enlarged diameter opening 60 also includes a counter bore and the free end 68 is spun or deformed over the flange portion 62 of the cover, forming a secure assembly. This embodiment of the housing 58 includes opposed aligned cylindrical openings 70 and inwardly projecting tubular portions 71 integral with the housing and strengthening the housing wall.

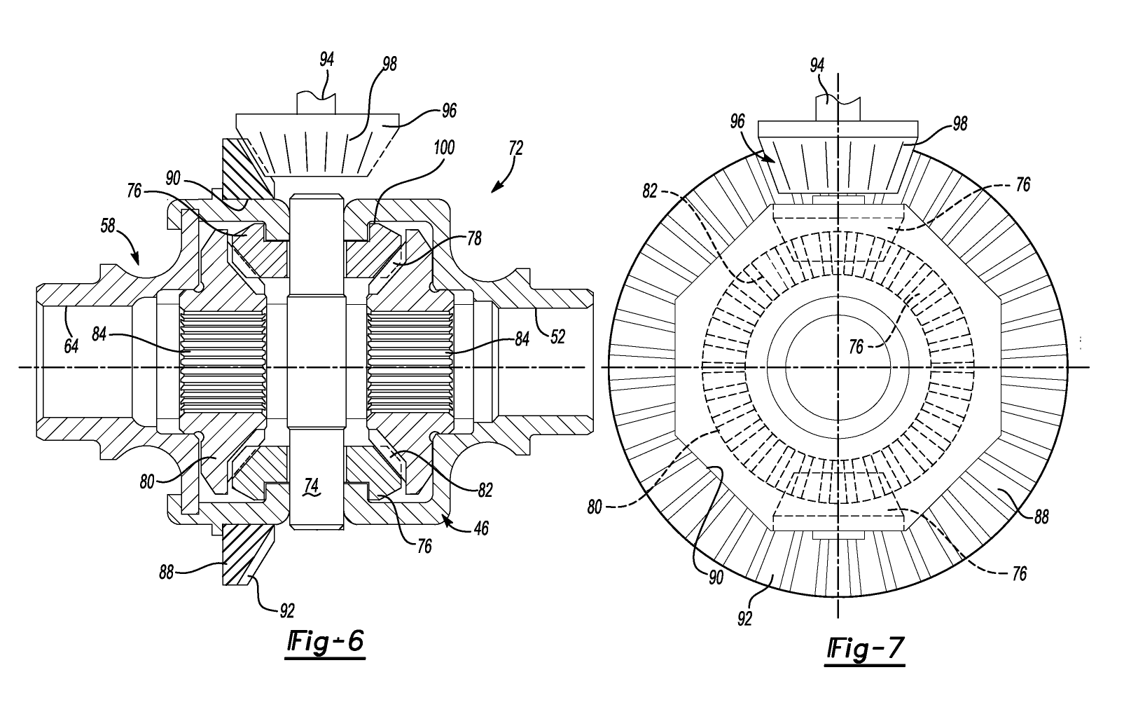

FIGS. 6 and 7 illustrate an automotive differential with a polygonal housing 46 formed by the method described above with regard to FIGS. 1 to 5. The automotive differential 72 includes the housing 46 shown in FIG. 5, including the cap 58, a center post 74 having cylindrical ends received in the opposed cylindrical openings 70 of the housing best shown in FIG. 5, two pinion gears 76 each having external gear teeth 78 and side gears 80 each having gear teeth meshing with the external gear teeth 78 of the pinion gears 76. The side gears 80 each further include coaxially aligned splined axial bores 84. As will be understood by those skilled in this art, the axel shafts having a splined end portion are received in the axial bore 52 of the housing and a second axial shaft is received in the axial bore 64 of the cap which are driven by the side gears and the housing. The external surfaces of the pinion gears 76 include flat surfaces 100 which engage the internal flat surfaces of the housing 46 transmitting torque from the housing to the side gears 80.

This embodiment of the automotive differential further includes a ring gear 88 having an octagonal opening 90 closely receiving the external flat surfaces 26 of the octagonal cross-section 22 of the housing. The ring gear 88 includes radial gear teeth 92 on the beveled surface and a driveshaft 94 having a frustoconical head portion 96 in this embodiment including gear teeth 98 which mesh with the gear teeth 92 of the ring gear 88 as shown in FIGS. 6 and 7. Thus, rotation of the driveshaft 94 rotates the ring gear 88 and the housing 46 which rotates the pinion gears 76 and the side gears 80 which rotate the axel shafts, not shown.

What is claimed is:

1. A torque transmitting assembly, comprising:
a tubular steel housing including a polygonal cross-section having a plurality of angularly related flat surfaces;
a torque transmitting member located within said housing having a flat surface engaging said angularly related flat surfaces of said housing; and
said torque transmitting member transmitting torque through said steel housing member upon application of torque to said torque transmitting member.

2. The torque transmitting assembly as defined in claim 1, wherein said torque transmitting assembly includes a ring gear having a central polygonal opening closely receiving said polygonal cross-section of said housing and a plurality of external gear teeth.

3. The torque transmitting assembly as defined in claim 1, wherein said torque transmitting member is a first gear member having a plurality of gear teeth.

4. The torque transmitting assembly as defined in claim 3, wherein said assembly includes a second gear member having a plurality of gear teeth mating with said gear teeth of said first gear member, and said second gear member transmitting torque to said tubular steel housing through said first gear member.

5. The torque transmitting assembly as defined in claim 1, wherein said tubular steel housing includes a reduced diameter portion adjacent a polygonal portion retaining the torque transmitting member in the housing.

6. The torque transmitting assembly as defined in claim 4, wherein the reduced diameter portion of said tubular steel housing includes a circular cross-section.

7. The torque transmitting assembly as defined in claim 1, wherein the cross-section of said tubular steel housing is a regular polygon.

8. The torque transmitting assembly as defined in claim 1, wherein the cross-section of said tubular steel housing is octagonal.

9. An automotive differential joint, comprising:
a tubular steel housing including a polygonal cross-section having a plurality of angularly related flat surfaces;
annular side gears within said housing each including an external flat surface engaging said angularly related flat surfaces of said tubular housing and said annular side gears including a plurality of annular gear teeth;
annular pinion gears within said housing including annular gear teeth meshing with said annular gear teeth of said annular side gears, and said annular pinion gears each including an axial bore having a plurality of angularly related internal flat surfaces; and
a shaft having a plurality of external angularly related flat surfaces meshing with said internal angularly related flat surfaces of said annular side gear and said shaft transmitting torque to said housing through said annular side gear and said annular pinion gear.

10. The automotive differential joint as defined in claim 9, wherein said differential joint further includes an annular ring gear including an axial polygonal bore received around said polygonal cross-section of said housing, said annular ring gear including a plurality of internal flat surfaces engaging external flat surfaces of said housing, and said ring gear including a plurality of generally radial gear teeth.

11. The automotive differential joint as defined in claim 10, wherein said automotive differential joint further includes a pinion gear having a frustoconical surface including gear teeth meshing with said external gear teeth of said annular ring gear, such that torque is transmitted by said pinion gear through said ring gear to said housing.

12. The automotive differential joint as defined in claim 9, wherein said housing includes a regular polygonal cross-section.
